(19) United States
(12) Patent Application Publication
(10) Pub. No.: US 2026/0332297 A1
(43) Pub. Date: Oct. 22, 2026

(54) LOW-DENSITY PARITY-CHECK BASE GRAPH SELECTION

(71) Applicant: Lenovo (United States) Inc., Morrisville, NC (US)

(72) Inventors: Abir Ben Hadj Fredj, Frankfurt am main (DE); Razvan-Andrei Stoica, Essen (DE)

(73) Assignee: Lenovo (United States) Inc., Morrisville, NC (US)

(21) Appl. No.: 19/638,635

(22) Filed: Apr. 3, 2026

(51) Int. Cl. H04L 1/00; H04W 72/232

(52) U.S. Cl. CPC H04L 1/0057; H04L 1/0003; H04L 1/0009; H04W 72/232

(57) ABSTRACT

Various aspects of the present disclosure relate to low-density parity-check (LDPC) base graph selection. A wireless communication device (e.g., a user equipment (UE) or a network equipment (NE)) selects an LDPC base graph from a set of LDPC base graphs based on a transport block size (TBS) and a modulation and coding scheme (MCS) index. The wireless communication device encodes a transport block (TB) based on the selected LDPC base graph and transmits the TB, for example, to a UE. In such cases, the UE receives the TB and decodes the TB based on the LDPC base graph.

### TECHNICAL FIELD

The present disclosure relates to wireless communications, and more specifically to low-density parity-check (LDPC) base graph selection.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., wireless communication devices, encoders, decoders, NE, UE), processors, and methods of the present disclosure each have several innovative aspects, no single one of which is solely responsible for the desirable features disclosed herein.

A wireless communication device (e.g., an encoder, a UE, an NE) for wireless communication is described. The wireless communication device may be configured to, capable of, or operable to perform one or more operations as described herein. For example, the wireless communication device may be configured to, capable of, or operable to select an LDPC base graph from a set of LDPC base graphs based on (e.g., based at least in part on) a transport block size (TBS) and a modulation and coding scheme (MCS) index, and encode a transport block (TB) based on the selected LDPC base graph.

A processor (e.g., a standalone processor chipset, or a component of a wireless communication device) for wireless communication is described. The processor may be configured to, capable of, or operable to perform one or more operations as described herein. For example, the processor may be configured to, capable of, or operable to select an LDPC base graph from a set of LDPC base graphs based on a TBS and an MCS index, and encode a TB based on the selected LDPC base graph.

A method performed or performable by a wireless communication device for wireless communication is described. The method may include selecting an LDPC base graph from a set of LDPC base graphs based on a TBS and an MCS index, and encoding a TB based on the selected LDPC base graph.

In some implementations of the wireless communication device, the processor, and the method described herein, the wireless communication device, the processor, and the method may further be configured to, capable of, or operable to transmit, to a UE, downlink control information (DCI) indicating the selected LDPC base graph. In some implementations, the DCI includes (e.g., comprises) a one-bit field indicating a base graph identifier (ID) of the selected LDPC base graph. In some implementations, the wireless communication device, the processor, and the method may further be configured to, capable of, or operable to transmit DCI indicating the MCS index, and transmit radio resource control (RRC) signaling indicating one or more parameters associated with the TBS. In some implementations, the wireless communication device, the processor, and the method may further be configured to, capable of, or operable to determine the TBS based on the RRC signaling, where (e.g., wherein) the MCS index and the determined TBS implicitly indicate a base graph ID for selecting the LDPC base graph from the set of LDPC base graphs.

In some implementations, the wireless communication device, the processor, and the method may further be configured to, capable of, or operable to determine the TBS and the MCS index, where the TBS is within a first TBS range and the MCS index is within a first MCS range, and where each LDPC base graph of the set of LDPC base graphs corresponds to a TBS range and an MCS range. In some implementations, the selected LDPC base graph corresponds to the first TBS range and the first MCS range and a second LDPC base graph corresponds to a second TBS range and a second MCS range, and the second TBS range includes larger TBSs than the first TBS range and the second MCS range includes larger MCS indices than the first MCS range. In some implementations, at least one LDPC base graph of the set of LDPC base graphs is configured for high-throughput scenarios. In some implementations, the selected LDPC base graph is associated with one or more TBs. In some implementations, the wireless communication device is a UE or an NE.

A UE for wireless communication is described. The UE may be configured to, capable of, or operable to perform one or more operations as described herein. For example, the UE may be configured to, capable of, or operable to receive a TB that is encoded based on an LDPC base graph, the LDPC base graph selected from a set of LDPC base graphs based on a TBS and an MCS index, and decode the TB based on the LDPC base graph.

A processor (e.g., a standalone processor chipset, or a component of a UE) for wireless communication is described. The processor may be configured to, capable of, or operable to perform one or more operations as described herein. For example, the processor may be configured to, capable of, or operable to receive a TB that is encoded based on an LDPC base graph, the LDPC base graph selected from a set of LDPC base graphs based on a TBS and an MCS index, and decode the TB based on the LDPC base graph.

A method performed or performable by a UE for wireless communication is described. The method may include receiving a TB that is encoded based on an LDPC base graph, the LDPC base graph selected from a set of LDPC base graphs based on a TBS and an MCS index, and decoding the TB based on the LDPC base graph.

In some implementations of the UE, the processor, and the method described herein, the UE, the processor, and the method may further be configured to, capable of, or operable to receive DCI indicating the LDPC base graph. In some implementations, the DCI includes a one-bit field indicating a base graph ID of the LDPC base graph. In some implementations, the UE, the processor, and the method may further be configured to, capable of, or operable to receive DCI indicating the MCS index, and receive RRC signaling indicating one or more parameters associated with the TBS. In some implementations, the UE, the processor, and the method may further be configured to, capable of, or operable to determine the TBS based on the RRC signaling, and select the LDPC base graph based on the MCS index and the determined TBS. In some implementations, the MCS index and the TBS implicitly indicate a base graph ID for selecting the LDPC base graph.

In some implementations, the TBS is within a first TBS range and the MCS index is within a first MCS range, and each LDPC base graph of the set of LDPC base graphs corresponds to a TBS range and an MCS range. In some implementations, the LDPC base graph corresponds to the first TBS range and the first MCS range and a second LDPC base graph corresponds to a second TBS range and a second MCS range, and the second TBS range includes larger TBSs than the first TBS range and the second MCS range includes larger MCS indices than the first MCS range. In some implementations, at least one LDPC base graph of the set of LDPC base graphs is configured for high-throughput scenarios. In some implementations, the LDPC base graph is associated with one or more TBs.

### BRIEF DESCRIPTION OF THE DRAWINGS

FIG. 1 illustrates an example of a wireless communications system in accordance with aspects of the present disclosure.

FIG. 2 illustrates an example of a TB configuration in accordance with aspects of the present disclosure.

FIGS. 3 and 4 illustrate examples of TBS determination schemes in accordance with aspects of the present disclosure.

FIG. 5 illustrates an example of a base graph structure in accordance with aspects of the present disclosure.

FIG. 6 illustrates an example of a transceiver chain in accordance with aspects of the present disclosure.

FIG. 7 illustrates an example of a process flow in accordance with aspects of the present disclosure.

FIG. 8 illustrates an example of a signaling diagram in accordance with aspects of the present disclosure.

FIG. 9 illustrates an example of a wireless communication device in accordance with aspects of the present disclosure.

FIG. 10 illustrates an example of a processor in accordance with aspects of the present disclosure.

FIG. 11 illustrates an example of a UE in accordance with aspects of the present disclosure.

FIG. 12 illustrates a flowchart of a method performed by a wireless communication device in accordance with aspects of the present disclosure.

FIG. 13 illustrates a flowchart of a method performed by a UE in accordance with aspects of the present disclosure.

### DETAILED DESCRIPTION

In a wireless communications system, a UE and an NE (e.g., a base station, gNB) may support wireless communication (e.g., reception and/or transmission of wireless communication) using time-frequency resources. To ensure reliable data transmission over wireless channels, which may be subject to noise and interference, the UE and the NE may employ error correction coding techniques. LDPC codes represent one class of forward error correction codes (FEC) that utilize sparse parity-check matrices to encode and decode data. Different LDPC base graphs may be defined to accommodate varying transmission requirements. As described herein, an LDPC base graph (also referred to herein as a base graph) is a matrix that serves as the basis for constructing a parity-check matrix used to encode and decode data in wireless communications, where different base graphs may be designed to accommodate varying transmission requirements such as different data block sizes, coding rates, and throughputs

In some wireless communications systems (e.g., 5G systems), LDPC codes may be used for enhanced mobile broadband (eMBB) data channels due to their performance near the Shannon capacity and their relatively low complexity encoding and decoding scheme. As used herein, the Shannon capacity may represent a theoretical maximum rate at which information may be reliably transmitted over a communication channel given a specific bandwidth and signal-to-noise ratio (SNR). LDPC decoders may be iterative decoders, such as belief propagation (BP) and min-sum product decoders, which are highly parallelizable and enable high throughputs (e.g., up to 20 Giga-bits-per-second (Gbps) for 5G NR). To enable high link performance for different code lengths and code rates, a 5G NR system may support two different base graphs for 5G NR quasi-cyclic LDPC (QC-LDPC) codes. A first base graph (BG1) may cover large payload sizes and high code rates, while a second base graph (BG2) may enable the encoding of small payloads and code rates (e.g., up to 2/3). For example, if A≤292, or if A≤3824 and R≤0.67, or if R≤0.25, LDPC BG2 is used; otherwise, LDPC BG1 is used, where A is the payload size and R is the code rate.

Such base graph selection criteria may be hard-coded within the LDPC encoding chain. As such, regardless of service throughput and energy efficiency quality of service (QoS) requirements, the encoder follows these rules when receiving a TB from higher layers. However, for some wireless communications systems beyond 5G NR (e.g., 6G wireless communications systems), different LDPC base graphs may be designed to match different scenario requirements, such as high throughput scenarios (e.g., 50 Gbps to 100 Gbps), high energy efficiency scenarios, and low code rate scenarios (e.g., below 0.2) for Internet of Things (IoT) devices.

Additionally, a UE or an NE may determine a TBS according to a formula-based approach that includes parameters such as one or more of a number of multiple-input multiple-output (MIMO) layers, an MCS index, an available bandwidth, a transmission duration, or overhead configured by RRC signaling. High throughput applications may require large TBs and high MCS indices. For example, 6G peak data rates may reach 36 Gbps for downlink and 18 Gbps for uplink transmissions. Achieving these data rates may require enhanced forward error correction (FEC) decoding throughput. As such, there is a need for an additional LDPC base graph, an LDPC base graph 3 (BG3) for ultra-high throughput scenarios, in addition to the existing base graphs BG1 and BG2.

Aspects of the present disclosure are described in the context of a wireless communications system, and include implementations that enable LDPC base graph selection to accommodate different throughput requirements. For example, a wireless communication device (e.g., a UE, an NE) may select an LDPC base graph based on parameters such as a TBS and an MCS index. In this way, the device may select a base graph (e.g., BG3) associated with ultra-high throughput scenarios based on the TBS and the MCS index, as high MCS values may be used for ultra-high throughput use cases. In some examples, the network or configuring entity may explicitly signal its base graph selection to a UE via DCI, which may also indicate the MCS index and parameters for determining the TBS. In some examples, the device may perform LDPC base graph selection during link adaptation and TBS determination. The wireless communication device may encode a TB based on the selected LDPC base graph and transmit the TB to the UE. The UE may decode the TB based on the LDPC base graph.

In some implementations, a wireless communication device may signal its LDPC base graph selection to a UE via Layer 1 (L1) signaling, such as DCI. In this case, the wireless communication device may select an LDPC base graph from among two or more predefined base graphs. For example, the wireless communication device may select a BG3, which may be associated with high peak data rate scenarios beyond 20 Gbps for downlink transmissions and 10 Gbps for uplink transmissions. For UE encoding and decoding operations, the base graph configuration may be signaled via DCI signaling within fields associated with TB determination. In one implementation, a base graph ID corresponding to the base graph signaling may be explicitly signaled as an additional DCI field.

By performing the described techniques, devices (e.g., a UE and an NE) in a wireless communications system may provide for improved throughput, enhanced encoding and decoding performance, and more efficient accommodation of varying transmission requirements. For example, the selection of an LDPC base graph from a set of LDPC base graphs based on a TBS and an MCS index may enable the wireless communication device to select a particular base graph (e.g., BG3) that is configured for ultra-high throughput scenarios, supporting peak data rates beyond conventional limits (e.g., 36 Gbps for downlink and 18 Gbps for uplink transmissions in 6G systems). This may enable improved FEC decoding throughput and enhanced link performance for different code lengths and code rates. Additionally, the base graph selection criterion based on TBS and MCS indices may accommodate scenarios where a third base graph for high-throughput applications (e.g., BG3) overlaps with existing base graphs (e.g., BG1), rendering existing selection criteria obsolete. The base graph selection described herein may be performed as part of the link adaptation procedure, and the base graph ID may be signaled to a UE via L1 signaling, such as DCI, enabling efficient coordination between the network and the UE for encoding and decoding operations. In some implementations, the MCS index and the TBS may implicitly indicate a base graph ID for selecting the LDPC base graph, eliminating the need for explicit base graph signaling and reducing control signaling overhead while improving spectral efficiency.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings, is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

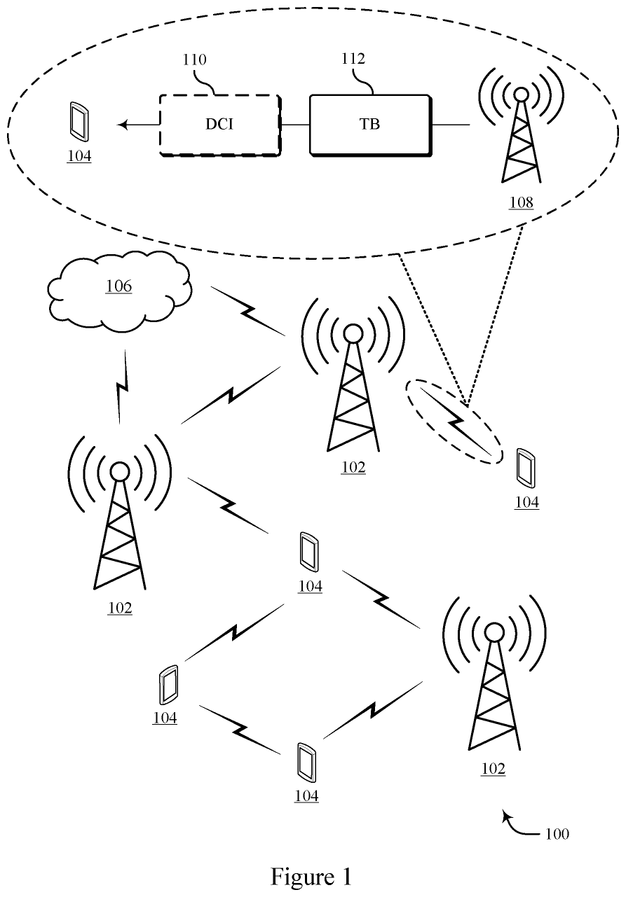

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be, or include, or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be movable, for example, a satellite associated with a non-terrestrial network (NTN). In some implementations, different geographic coverage areas associated with the same or different radio access technologies may overlap, but the different geographic coverage areas may be associated with different NEs 102.

The one or more UEs 104 may be dispersed throughout a geographic region of the wireless communications system 100. A UE 104 may include, or may be referred to as, a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or a machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NEs 102 or the CN 106 through one or more backhaul links (e.g., S1, N2, N6, or other network interface). In some implementations, the NEs 102 may communicate with each other directly. In some other implementations, the NEs 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHZ), FR4 (52.6 GHz-114.25 GHZ), FR4a or FR4-1 (52.6 GHz-71 GHz), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, wireless communication devices, including NEs 102 and the UEs 104, are operable to implement various aspects of the techniques described with reference to the present disclosure. For example, the wireless communications system 100 enables LDPC base graph selection to accommodate different throughput requirements. For example, a wireless communication device (e.g., a UE 104, an NE 102) may select an LDPC base graph based on parameters such as a TBS and an MCS index. For example, the device may select a base graph (e.g., BG3) associated with ultra-high throughput scenarios based on the TBS and the MCS index, as high MCS values may be used for ultra-high throughput use cases. In some examples, the device may explicitly signal its base graph selection to a UE 104 via DCI 110, which may also indicate the MCS index and parameters for determining the TBS. The wireless communication device may encode a TB 112 based on the selected LDPC base graph and transmit the TB 112 to the UE 104. The UE 104 may decode the TB 112 based on the LDPC base graph.

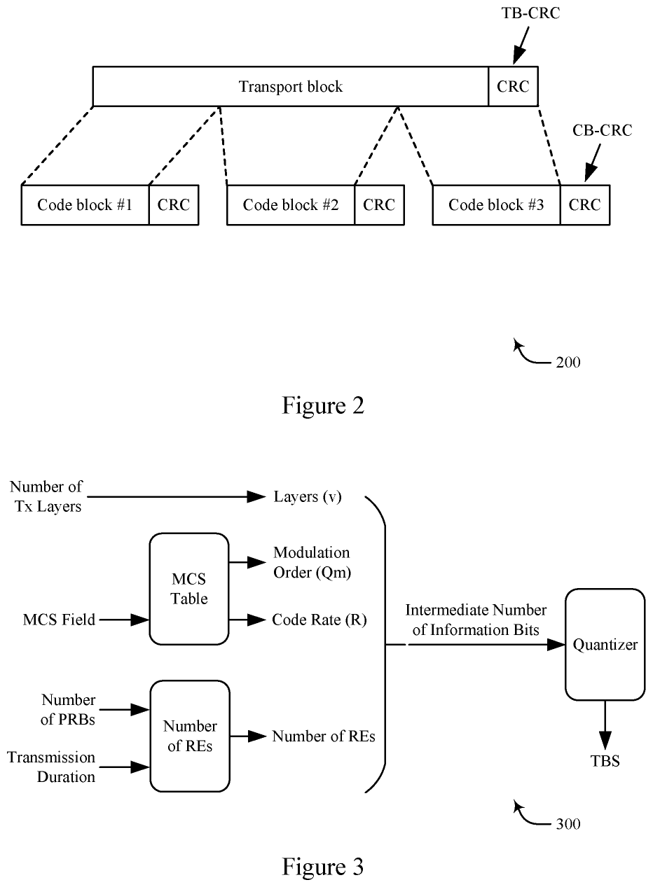

FIG. 2 illustrates an example of a TB configuration 200 in accordance with aspects of the present disclosure. In the example of FIG. 2, the TB configuration 200 depicts the structure and segmentation of a TB with an appended TB-cyclic redundancy check (TB-CRC). The TB may include payload data that is communicated between a medium access control (MAC) layer and a physical (PHY) layer of a device (e.g., a transmitter) for transmission over shared data channels, such as a physical downlink shared channel (PDSCH) or a physical uplink shared channel (PUSCH). The TB-CRC is attached to the TB to enable error detection at the receiver.

Additionally, the TB configuration 200 illustrates the segmentation of the TB into multiple code blocks. By way of example, the TB may be segmented into three code blocks: code block #1, code block #2, and code block #3. Each code block may have an appended code block CRC (CB-CRC) for error detection purposes at the code block level. Segmentation of the TB may occur when the TBS exceeds a maximum code block size supported by a selected LDPC base graph. For example, for LDPC BG1, the maximum code block size may be 8448 bits, while for LDPC BG2, the maximum code block size may be 3840 bits (where the TB may include millions of bits and each code block may include up to 8448 bits).

FIG. 3 illustrates an example of a TBS determination scheme 300 in accordance with aspects of the present disclosure. The TBS determination scheme 300 may implement or be implemented by aspects of the wireless communications system 100 and the TB configuration 200. For example, a wireless communication device (e.g., a UE, an NE) may use the TB configuration 200 in conjunction with the TBS determination scheme 300 to determine (e.g., identify, calculate, compute) a TBS.

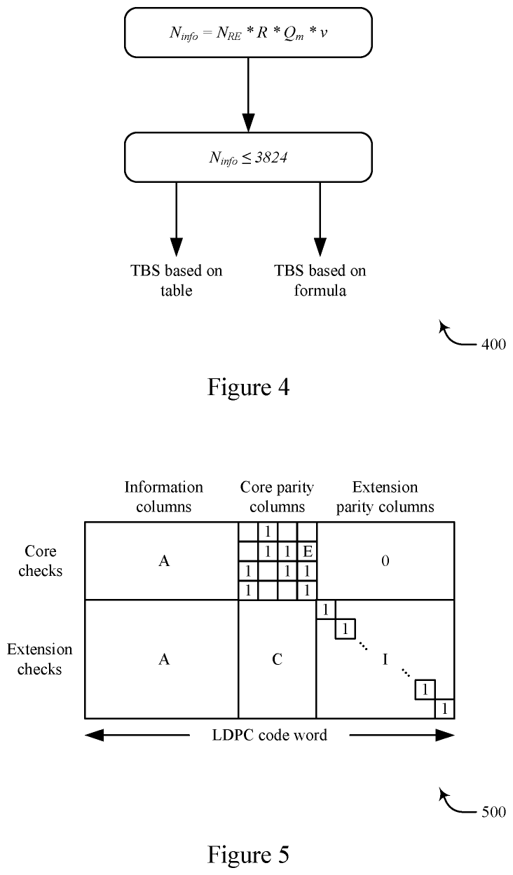

In some examples, a UE (e.g., a receiver) receiving data on a PDSCH may determine a TBS before attempting to decode the data. The UE may use information provided via RRC signaling and DCI over a physical downlink control channel (PDCCH), depending on a scheduling type (e.g., semi-static or dynamic scheduling) to determine the TBS. In the example of FIG. 3, the information may include various parameters that affect the TBS, such as a number of transmit (Tx) layers, a number of layers (v), a modulation order (Qₘ), a coding rate (R), a number of physical resource blocks (PRBs), a transmission duration, and so forth. For example, based on an MCS field (e.g., indicated via DCI or RRC signaling), the UE may use an MCS table to determine the modulation order and the code rate. In addition, the UE may determine a number of resource elements (REs) based on the number of PRBs and the transmission duration. Based on the layers, the modulation order, the code rate, and the number of REs, the UE may determine an intermediate number of information bits (e.g., N_{info} as described herein with reference to FIG. 4), which a quantizer may convert into the TBS. In some examples, the TBS determination scheme 300 may be modified if any of the parameters change.

FIG. 4 illustrates an example of a TBS determination scheme 400 in accordance with aspects of the present disclosure. The TBS determination scheme 400 may implement or be implemented by aspects of the wireless communications system 100, the TB configuration 200, and the TBS determination scheme 300. For example, a wireless communication device (e.g., a UE, an NE) may use the TB configuration 200 in conjunction with the TBS determination scheme 300 and the TBS determination scheme 400 to determine (e.g., identify, calculate, compute) a TBS.

As described herein with reference to FIG. 3, a UE may determine a TBS based on various parameters, such as a modulation order, a code rate, and so forth. However, such a TBS determination scheme (e.g., the TBS determination scheme 300 of FIG. 3) may be modified when any of the parameters change. As such, a UE (e.g., in a 5G NR wireless communications system) may use a formula-based approach combined with a table to determine TBSs, which may be a more flexible approach. For example, as illustrated in FIG. 4, the UE may determine an intermediate number of information bits, N_{info}, as N_{info}=N_{RE}*R*Qₘ*v, where N_{RE} represents a number of REs, R represents a coding rate, Qₘ represents a modulation order, and v represents a number of layers. The UE may calculate N_{info}≤3824 bits, and then determine the TBS using this value with a table or based on a formula. In some examples, the UE may determine (e.g., identify, calculate, compute)

$${N}_{RE}^{′} ,$$

which represents a number of REs that are available for data transfer within the bandwidth of a single resource block (RB), using the formula

$${N}_{R E}^{′} = {N}_{S C}^{R B} * {N}_{s y m b l}^{s h} - {N}_{D M R S}^{P B R} - {N}_{o h}^{P R B} ,$$

where

$${N}_{SC}^{R B}$$

represents a number of subcarriers per RB

$${N}_{s y m b l}^{s h}$$

represents a number of symbols allocated for a shared channel,

$${N}_{DMRS}^{PBR}$$

represents a number of demodulation reference signals (DMRSs) per PRB, and

$${N}_{oh}^{PRB}$$

represents an overhead per PRB.

FIG. 5 illustrates an example of a base graph structure 500 in accordance with aspects of the present disclosure. The base graph structure 500 may implement or be implemented by aspects of the wireless communications system 100. In the example of FIG. 5, the base graph structure may be applicable to BG1 and BG2. The base graph structure 500 depicts the organization of an LDPC code word with columns divided into three categories: information columns, core parity columns, and extension parity columns. The base graph structure 500 includes rows divided into core checks and extension checks. For the core checks row, the base graph structure 500 includes a matrix A corresponding to the information columns, a matrix E with a dual diagonal structure corresponding to the core parity columns, and a zero matrix corresponding to the extension parity columns. For the extension checks row, the base graph structure 500 includes a matrix A corresponding to the information columns, a matrix C corresponding to the core parity columns, and an identity matrix I corresponding to the extension parity columns. The base graph structure 500 represents the high-level organization used for LDPC encoding and decoding operations, where the parity-check matrix may be constructed based on the base graph to enable efficient encoding of information bits and generation of parity bits for error correction.

In some wireless communications systems, such as 5G NR systems, LDPC codes may be implemented as QC-LDPC codes. H_{BG}M×N H_{BG}A QC-LDPC code may be constructed from a base graph matrix, denoted as H_{BG}, having dimensions M× N. The base graph matrix may be selected during the coding process based on the coding rate and the length of the TB or code block. For example, a first base graph (e.g., BG1) may have dimensions where N=68 and M=46, while a second base graph (e.g., BG2) may have dimensions where N=52 and M=42. BG1 may be configured for larger block lengths (e.g., K≤8448 bits) and coding rates between 1/3 and 8/9, while BG2 may be configured for smaller blocks (e.g., K≤3840 bits) and coding rates between 1/5 and 2/3.

The maximum number of information bits K may be determined based on a lifting size Z_{c}, where K=22Z_{c} for BG1 and K=10Z_{c} for BG2. The lifting size represents a scaling factor used to expand the base graph matrix into a full parity-check matrix, and multiple lifting sizes (e.g., 51 lifting sizes ranging from 2 to 384) may be supported for each base graph. Example lifting sizes for BG1 and BG2 are depicted in Table 1. Both BG1 and BG2 may share a common block structure, as illustrated in the base graph structure 500 of FIG. 5. The columns of the base graph structure may be organized into information columns, core parity columns, and extension parity columns. The rows may be divided into core check rows and extension check rows. The sub-matrix E within the core parity columns may be implemented as a dual diagonal matrix (also referred to as a double diagonal matrix), which provides computational benefits for encoding operations by enabling efficient generation of parity bits. Each element within the base graph matrix may include a circular shift value that defines how sub-matrices are shifted when constructing the full parity-check matrix from the base graph.

TABLE 1
Lifting sizes of 5G NR LDPC codes (BG1 and BG2)

| Set index (iLS) | Set of lifting sizes (Z) |
|---|---|
| 0 | 2, 4, 8, 16, 32, 64, 128, 256 |
| 1 | 3, 6, 12, 24, 48, 96, 192, 384 |
| 2 | 5, 10, 20, 40, 80, 160, 320 |
| 3 | 7, 14, 28, 56, 112, 224 |
| 4 | 9, 18, 36, 72, 144, 288 |
| 5 | 11, 22, 44, 88, 176, 352 |
| 6 | 13, 26, 52, 104, 208 |
| 7 | 15, 30, 60, 120, 240 |

NR LDPC codes may offer an additional coding advantage at lower code rates, rendering them suitable for scenarios requiring high reliability. Regarding decoding complexity, opting for BG2 may be advantageous because of the compactness and utilization of a larger lifting size element of BG2. This may enhance parallelism compared to BG1. Decoding latency may correlate with a number of non-zero elements in the base graph, with BG2 exhibiting significantly lower latency than BG1 for a given code rate, owing to its fewer non-zero elements. Additionally, the parity-check matrix H may be obtained by replacing each element of the base graph H_{BG} with a Z_{c}×Z_{c} matrix according to various rules. For example, each element of value −1 in H_{BG} may be replaced by a null matrix of size Z_{c}×Z_{c}. Additionally, each element of value 0 in H_{BG} may be replaced by an identity matrix I of size Z_{c}×Z_{c}. Additionally, each element of value 1 to Z_{c}−1 in H_{BG}, denoted by p_{i,j}, may be replaced by a circular permutation matrix I(p_{i,j}) of size Z_{c}×Z_{c}, where i and j may represent the row and column indices of the element, and I(p_{i,j}) may be obtained by circularly shifting the identity matrix I of size Z_{c}×Z_{c} to the right p_{i,j} times. Using a circularly shifting identity matrix in this way may reduce a memory requirement for implementation.

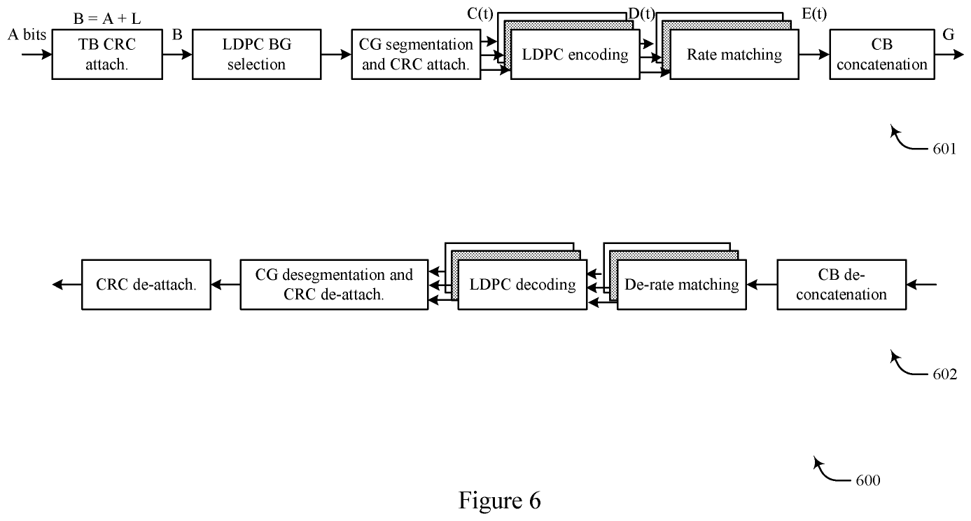

FIG. 6 illustrates an example of a transceiver chain 600 in accordance with aspects of the present disclosure. The transceiver chain 600 may implement or be implemented by aspects of the wireless communications system 100. In the example of FIG. 6, the transceiver chain may include a transmitter end 601 and a receiver end 602. In some examples, an input bit sequence to a code block segmentation may be denoted by b₀, b₁, b₂, . . . b_{B-1}, where B>0. If B is larger than the maximum code block size K_{cb}, the input bit sequence may be segmented and an additional CRC sequence of L=24 bits may be attached to each code block. A maximum code block size may be K_{cb}=8448 for LDPC BG1 and K_{cb}=3840 for LDPC BG2. The bit sequence input for a given code block-to-channel coding may be denoted by c₀, c₁, c₂, . . . c_{K-1}, where K represents the number of bits to encode. After encoding, the bits may be denoted by d₀, d₁, d₂, . . . d_{N-1}, where N=66Z_{c} for LDPC BG1 and N=50Z, for LDPC BG2, and the value of Z_{c} may be provided. In some examples, if A≤292, or if A≤3824 and R≤0.67, or if R≤0.25, LDPC BG2 is used; otherwise, LDPC BG1 is used, where A is the payload size and R is the code rate.

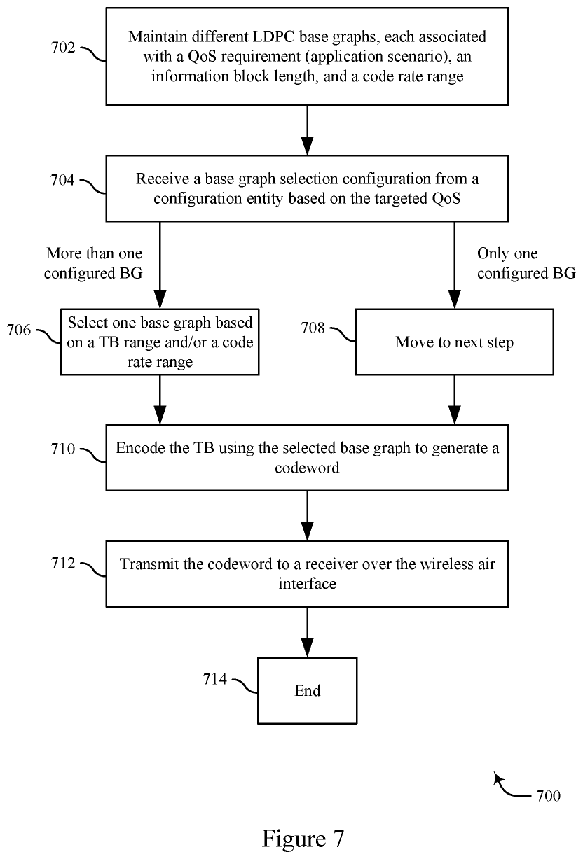

FIG. 7 illustrates an example of a process flow 700 in accordance with aspects of the present disclosure. The process flow 700 may implement or be implemented by aspects of the wireless communications system 100. Alternative examples of the following may be implemented, where some processes are performed in a different order than described or are not performed. In some cases, processes may include additional features not mentioned below, or further processes may be added. The process flow 700 depicts an example of LDPC base graph selection when two or more base graphs are used to encode a TB, as described herein. The process flow 700 may be performed by wireless communication devices, such as UEs, NEs, encoders and decoders, or receivers and transmitters.

At 702, a wireless communication device may maintain different LDPC base graphs, each base graph associated with a QoS requirement (e.g., associated with an application scenario). In some examples, each LDPC base graph may also be associated with a TB (e.g., information block) length and a code rate range. Application scenarios with applicable QoS requirements may include ultra-high throughput scenarios (e.g., around 50 Gbps to 100 Gbps) for use cases such as massive digital twins and high-fidelity extended reality (XR) streaming, which require high decoding throughput and LDPC base graphs that support high lifting sizes Z_{c} (e.g., beyond 384) to guarantee higher parallelism. Such base graphs may be designed so that the number of decoding iterations is reduced while maintaining capacity-approaching performance, and a base graph associated with ultra-high throughputs may be designed to be sparser (e.g., fewer edges within a Tanner graph, which is a bipartite graph representation of the parity-check matrix used to visualize and implement LDPC decoding operations), while maintaining good performance at high code rates (up to R=11/12). The application scenario QoS may also include IoT device requirements for low-tier and high-tier devices that operate at low code rates (e.g., R=0.2) and have stringent requirements on energy efficiency (e.g., battery life up to 10 years), which may require an adapted LDPC base graph that enables high performance at very low code rates, fewer edges within the Tanner graph (e.g., sparser parity-check matrices), and early-termination decoding techniques.

Additionally, or alternatively, a QoS requirement for a given application scenario may include high-reliability ultra-reliable low-latency communication (HURLLC) use cases, such as factory automation, tele-surgery, and autonomous driving, which require ultra-reliable (e.g., block error rate (BLER) approximately 10⁻⁵-10⁻⁷) and low-latency communications. This may be achieved when the LDPC base graph is designed such that error floors are avoided for different combinations of code rates and code block lengths. Such error floor avoidance may be accomplished by adopting an LDPC base graph construction that targets larger Tanner graph girth and enables fewer trapping sets. Additionally, low latency may be enabled by early termination decoding techniques. Base graphs may also be designed to enable fewer decoding iterations and faster decoding convergence (e.g., around 4 to 8 iterations). Additionally, or alternatively, QoS requirements for a given application scenario may include enhanced spectral efficiency scenarios for ultra-dense urban environments. Such scenarios may require an LDPC base graph designed to enable high MCS values while maintaining good link performance for different channel conditions, including non-line-of-sight (NLOS) scenarios. Additionally, such scenarios may require joint coding-modulation designs that enable high-order modulation (e.g., 1024-QAM, 4096-QAM, and beyond). Such joint coding-modulation designs may leverage LDPC code strengths to compensate for performance loss caused by denser QAM modulations and approach the bit-interleaved coded modulation (BICM) channel capacity.

In some implementations, two or more base graphs may be associated with one or more QoS metrics and application scenarios. The wireless communication device may maintain a set of multiple (e.g., a plurality of) LDPC base graphs, including at least a first LDPC base graph associated with a first TB (e.g., information block) length and code rate range, a second LDPC base graph associated with a second TB length and code rate range, and a third LDPC base graph associated with a third TB length and code rate range. The second TB length and code rate range may include a subset of the first TB length and code rate range, and the third TB length and code rate range may include a subset of the first or second TB length and code rate range.

At 704, the wireless communication device may receive a base graph selection configuration from a configuration entity (e.g., an NE) based on the targeted QoS (e.g., the considered application scenario). The example, the base graph selection configuration may include one or more configured base graphs for selection. At 706, if more than one base graph is configured, then the wireless communication device may select one base graph based on one or more of a TB (e.g., information block) range or a code rate range. Depending on the application scenario and associated QoS, the wireless communication device may select an LDPC base graph among two or more predefined base graphs to accommodate the QoS requirements of an application scenario. For example, the wireless communication device may select BG3, which may be associated with high peak data rate scenarios beyond 20 Gbps for downlink transmissions and 10 Gbps for uplink transmissions.

In some implementations, a wireless communication device (e.g., an NE) may configure a UE with multiple base graph IDs for an application scenario. The wireless communication device may signal the base graph IDs to the UE via higher layer signaling (e.g., RRC signaling) or via DCI signaling (e.g., within the MCS field). In such cases, when configured with multiple base graphs, the UE may select one of the configured base graphs based on one or more parameters, such as a TB (e.g., information block) length range or a code rate range. For example, if the same 5G NR base graphs (BG1 and BG2) are used, the UE may follow the same 5G NR rule for selecting the base graph, namely: the UE may use LDPC BG2 if A≤292, or if A≤3824 and R≤0.67, or if R≤ 0.25; otherwise, the UE may use LDPC BG1, where A is the payload size and R is the code rate. In some implementations, the UE may select the base graph that enables the use of higher lifting sizes to expand the base graph into a parity-check matrix, which enables higher parallelism at the decoder. In some examples, the wireless communication device may perform the base graph selection during a link adaptation procedure according to the application scenario performance requirements. The wireless communication device may signal a base graph number (e.g., BG3) or a base graph ID (e.g., BG_ID) of the selected base graph to the UE along with TBS information, and the UE may also select the base graph based on the signaled base graph number or ID.

In some implementations, the base graphs BG1, BG2, and BG3 may be selected (e.g., determined, identified) based on a TBS and an MCS index. In some examples, the wireless communication device may select a base graph in this way based on two specific criteria. First, during TBS determination, the wireless communication device may select the BG3 when the TBS is larger than a threshold TB≥TBₜₕᵣ and an MCS value is selected from a set of MCS values associated with high data rate scenarios, such as i_{MCS}=24, 25, 26, when high spectral efficiency is targeted and QAM modulation is 1024-QAM. MCS values may also be chosen from a pool of MCS indices that target high code rates and high QAM modulations.

For UE encoding and decoding operations, the wireless communication device may signal the base graph selection via DCI signaling within fields associated with TB determination. In one implementation, the base graph signaling may be explicit, where a base graph ID may be explicitly signaled as an additional DCI field. In this case, the DCI field may be an additional two-bit field that carries the base graph ID. Alternatively, the base graph ID of the base graph selected for encoding the TB may be implicitly signaled to a UE. In this case, the UE may be configured with combinations of TBSs and MCS indices. For example, upon receiving DCI and RRC configuration associated with TBS determination, the UE may determine, according to the received configuration, which base graph to select among one or multiple base graphs. If the combination of TBS and MCS is part of a predefined (e.g., TBS, MCS) set, then the UE may select BG3 to encode or decode the corresponding TB. The configuration may be associated with multiple TBs or may be specific to a single TB.

The wireless communication device may signal the selected base graph to the UE via L1 signaling, such as via DCI, along with an MCS field. The maximum TB size may be defined in 5G as a function of the maximum available bandwidth, the maximum number of MIMO layers, and the maximum MCS index. For 6G networks, higher bandwidths and MIMO layers may enable larger TBs beyond the 5G limit of approximately 1.3 Mbits, which may be useful for high-throughput scenarios. In such cases, the selection of an LDPC base graph, such as BG3 targeted for these scenarios, may be determined along with and based on the TBS. Table 2 depicts various fields of an example DCI format 1_0 to indicate a selected base graph.

TABLE 2
DCI format 1_0

| Field (Item) | Bits | Reference |
|---|---|---|
| Identifier for DCI formats | 1 | Always set to 1, meaning this is for |
| | | downlink |
| Frequency domain resource assignment | Variable | Variable with downlink bandwidth part |
| (FDRA) | | (BWP) N_RB |
| | | log₂(N_{RB}^{DL, BWP(}N_{RB}^{DL, BWP} + 1)/2) |
| Time domain resource assignment | 4 | Carries the row index of the items in |
| (TDRA) | | pdsch_allocationList in RRC |
| Virtual resource block (VRB)-to-PRB | 1 | According to 38.212 Table 7.3.1.1.2-33 |
| mapping | | 0: Non-Interleaved |
| | | 1: Interleaved |
| MCS | 5 | TS 38.214 - Table 5.1.3.1-1: MCS index |
| | | table 1 for PDSCH |
| | | TS 38.214 - Table 5.1.3.1-2: MCS index |
| | | table 2 for PDSCH |
| Base graph indication | 1 | Indicate the base graph ID based on TBS |
| | | and MCS values |
| New data indicator (NDI) | 1 | |
| Redundancy version (RV) | 2 | |
| Hybrid automatic repeat request (HARQ) | 4 | |
| process number | | |
| Downlink assignment index | 2 | |
| Transmit power control (TPC) command | 2 | |
| for scheduled physical uplink control | | |
| channel (PUCCH) | | |
| PUCCH resource indicator | 3 | |
| PDSCH-to-HARQ_feedback timing | 3 | maps to k1 = {1, 2, 3, 4, 5, 6, 7, 8} |
| indicator | | |

Alternatively, at 708, if only one base graph is configured, then the wireless communication device may proceed to step 710 with the configured base graph. At 710, the wireless communication device may encode the TB based on (e.g., using) the selected base graph to generate a codeword. In addition, at 712, the wireless communication device may transmit the codeword to a receiver (e.g., a UE) over a wireless air interface (e.g., a communication channel). In some implementations, the wireless communication device may utilize the selected LDPC base graph to encode a TB and produce a codeword for transmission over a wireless air interface to a receiving wireless communication device (e.g., a UE) via a transceiver. The codeword may include information bits of the TB and parity-check bits generated using the selected LDPC base graph. Alternatively, the UE may receive a codeword over a wireless air interface from a transmitter, select an LDPC base graph from the set of LDPC base graphs for decoding the codeword based on a TB length associated with the codeword. The UE may then decode the codeword using the selected LDPC base graph to obtain a TB having the TB length. The decoding enhancements described herein may be implemented within the wireless communication device, a UE, an NE, or any other network entity that transmits and receives data over a noisy channel. The channel may be an additive white Gaussian noise (AWGN) channel.

At 714, the base graph selection process described herein may end (e.g., is complete).

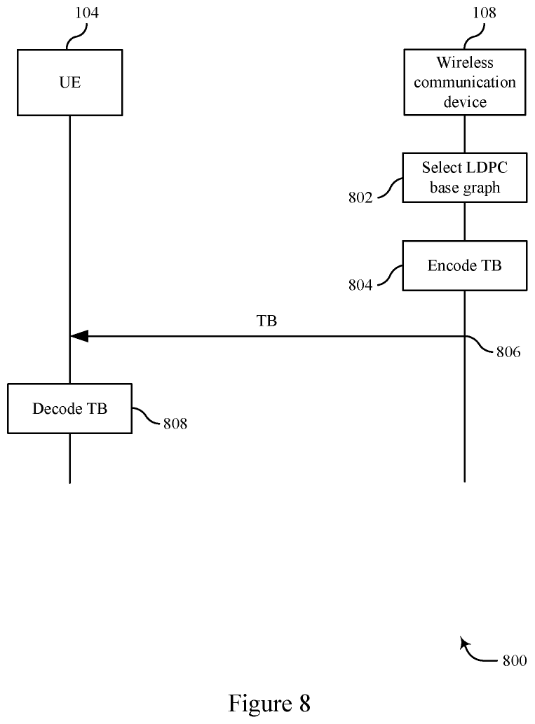

FIG. 8 illustrates an example of a signaling diagram 800 in accordance with aspects of the present disclosure. In some examples, the signaling diagram 800 implements or is implemented by aspects of the wireless communications system 100 and the process flow 700. The signaling diagram 800 may implement or be implemented by a UE 104 and a wireless communication device 108, which may be examples of the corresponding devices as described with reference to FIGS. 1 through 7. Alternative examples of the following may be implemented, where some processes are performed in a different order than described or are not performed. In some cases, processes may include additional features not mentioned below, or further processes may be added.

At 802, the wireless communication device 108 may select an LDPC base graph from a set of LDPC base graphs based on a TBS and an MCS index. In some implementations, the wireless communication device 108 may determine the TBS and the MCS index, where the TBS is within a first TBS range and the MCS index is within a first MCS range. Each LDPC base graph of the set of LDPC base graphs may correspond to a TBS range and an MCS range. For example, the selected LDPC base graph may correspond to the first TBS range and the first MCS range, and a second LDPC base graph may correspond to a second TBS range and a second MCS range. In some implementations, the second TBS range may include larger TBSs than the first TBS range and the second MCS range may include larger MCS indices than the first MCS range. In some implementations, at least one LDPC base graph of the set of LDPC base graphs may be configured for high-throughput scenarios, such as scenarios requiring peak data rates beyond 20 Gbps for downlink transmissions and 10 Gbps for uplink transmissions. In some implementations, the selected LDPC base graph may be associated with one or more TBs. In some implementations, the wireless communication device 108 may be a UE or an NE.

At 804, the wireless communication device 108 may encode a TB based on the selected LDPC base graph. The wireless communication device 108 may utilize the selected LDPC base graph to encode the TB and produce a codeword for transmission. The codeword may include information bits of the TB and parity-check bits generated using the selected LDPC base graph.

At 806, the wireless communication device 108 may transmit the TB to the UE 104. In some implementations, the wireless communication device 108 may transmit, to the UE 104, DCI indicating the selected LDPC base graph. In some implementations, the DCI may include a one-bit field indicating a base graph ID of the selected LDPC base graph. For example, a value of 0 may correspond to a first base graph and a value of 1 may correspond to a third base graph. In some implementations, the wireless communication device 108 may transmit DCI indicating the MCS index, and transmit RRC signaling indicating one or more parameters associated with the TBS. In some implementations, the wireless communication device 108 may determine the TBS based on the RRC signaling, where the MCS index and the determined TBS implicitly indicate a base graph ID for selecting the LDPC base graph from the set of LDPC base graphs. In such cases, the UE 104 may be configured with combinations of TBSs and MCS indices, and upon receiving DCI and RRC configuration associated with TBS determination, the UE 104 may determine, according to the received configuration, which base graph to select among one or multiple base graphs.

At 808, the UE 104 may receive the TB that is encoded based on the LDPC base graph, the LDPC base graph selected from the set of LDPC base graphs based on the TBS and the MCS index. The UE 104 may decode the TB based on the LDPC base graph. In some implementations, the UE 104 may receive DCI indicating the LDPC base graph, where the DCI may include a one-bit field indicating a base graph ID of the LDPC base graph. In some implementations, the UE 104 may receive DCI indicating the MCS index, and receive RRC signaling indicating one or more parameters associated with the TBS. The UE 104 may determine the TBS based on the RRC signaling, and select the LDPC base graph based on the MCS index and the determined TBS. In some implementations, the MCS index and the TBS may implicitly indicate a base graph ID for selecting the LDPC base graph.

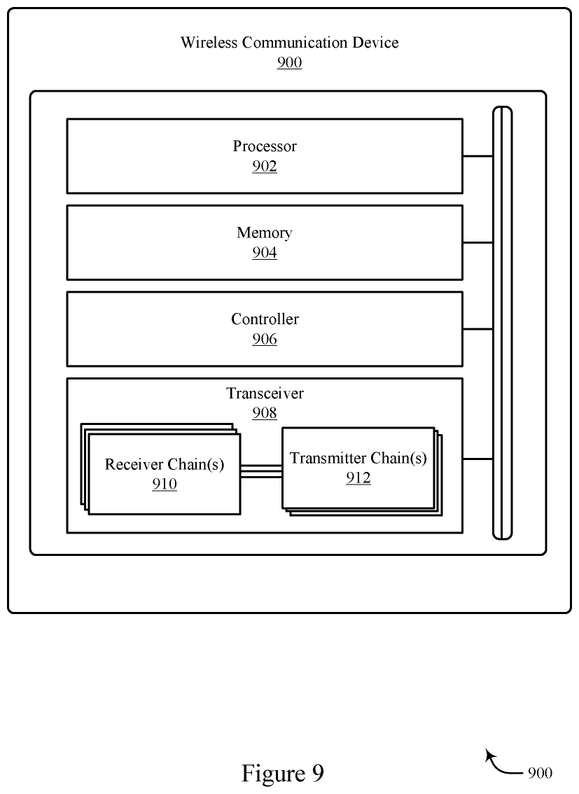

FIG. 9 illustrates an example of a wireless communication device 900 in accordance with aspects of the present disclosure. The wireless communication device 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a central processing unit (CPU), an ASIC, a field-programmable gate array (FPGA), or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the wireless communication device 900 to perform various functions of the present disclosure.

The memory 904 may include volatile or non-volatile memory. The memory 904 may store computer-readable, computer-executable code including instructions that, when executed by the processor 902, cause the wireless communication device 900 to perform various functions described herein. The code may be stored in a non-transitory computer-readable medium such as the memory 904 or another type of memory. Computer-readable media include both non-transitory computer storage media and communication media, including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the wireless communication device 900 to perform one or more of the functions described herein (e.g., executing, by the processor 902, instructions stored in the memory 904). For example, the processor 902 may support wireless communication at the wireless communication device 900 in accordance with examples as disclosed herein. The wireless communication device 900 may be configured to or operable to support a means for selecting an LDPC base graph from a set of LDPC base graphs based on a TBS and an MCS index, and encoding a TB based on the selected LDPC base graph. In this manner, the wireless communication device 900 supports improved throughput and enhanced encoding performance by enabling selection of an appropriate LDPC base graph that matches the transmission requirements, thereby accommodating varying scenarios, including ultra-high throughput applications.

Additionally, the wireless communication device 900 may be configured to or operable to support any one or combination of transmitting, to a UE, DCI indicating the selected LDPC base graph. This aspect enables efficient signaling of the selected base graph, reducing latency in base graph determination and ensuring proper coordination for encoding and decoding operations. Additionally, or alternatively, the wireless communication device 900 may be configured to or operable to support where the DCI includes a one-bit field indicating a base graph ID of the selected LDPC base graph. This aspect minimizes signaling overhead while providing explicit base graph indication, improving spectral efficiency and reducing control channel resource consumption. Additionally, or alternatively, the wireless communication device 900 may be configured to or operable to support transmitting DCI indicating the MCS index, and transmitting RRC signaling indicating one or more parameters associated with the TBS. This aspect enables accurate communication of transmission parameters for proper encoding and decoding, improving reliability and reducing errors. Additionally, or alternatively, the wireless communication device 900 may be configured to or operable to support determining the TBS based on the RRC signaling, where the MCS index and the determined TBS implicitly indicate a base graph ID for selecting the LDPC base graph from the set of LDPC base graphs. This aspect eliminates the need for explicit base graph signaling, reducing control signaling overhead and improving spectral efficiency.

Additionally, or alternatively, the wireless communication device 900 may be configured to or operable to support determining the TBS and the MCS index, where the TBS is within a first TBS range and the MCS index is within a first MCS range, and where each LDPC base graph of the set of LDPC base graphs corresponds to a TBS range and an MCS range. This aspect enables systematic base graph selection based on defined parameter ranges, improving encoding reliability and ensuring optimal base graph matching for different transmission scenarios. Additionally, or alternatively, the wireless communication device 900 may be configured to or operable to support where the selected LDPC base graph corresponds to the first TBS range and the first MCS range and a second LDPC base graph corresponds to a second TBS range and a second MCS range, and where the second TBS range includes larger TBSs than the first TBS range and the second MCS range includes larger MCS indices than the first MCS range. This aspect enables differentiated base graph selection for varying throughput requirements, improving performance for both standard and high-throughput scenarios. Additionally, or alternatively, the wireless communication device 900 may be configured to or operable to support where at least one LDPC base graph of the set of LDPC base graphs is configured for high-throughput scenarios. This aspect enables the wireless communication device 900 to support ultra-high data rates beyond conventional limits, improving peak throughput performance for demanding applications. Additionally, or alternatively, the wireless communication device 900 may be configured to or operable to support where the selected LDPC base graph is associated with one or more TBs. This aspect enables consistent base graph application across multiple TBs, improving encoding efficiency and reducing processing complexity. Additionally, or alternatively, the wireless communication device 900 may be configured to or operable to support where the wireless communication device is a UE or an NE. This aspect enables flexible deployment across different device types in the wireless communications system.

Additionally, or alternatively, the wireless communication device 900 may support at least one memory (e.g., the memory 904) and at least one processor (e.g., the processor 902) coupled with the at least one memory and configured to cause the wireless communication device 900 to select an LDPC base graph from a set of LDPC base graphs based on a TBS and an MCS index, and encode a TB based on the selected LDPC base graph. In this manner, the wireless communication device 900 supports improved throughput and enhanced encoding performance by enabling selection of an appropriate LDPC base graph that matches the transmission requirements, thereby accommodating varying scenarios including ultra-high throughput applications.

Additionally, the wireless communication device 900 may be configured to support any one or combination of transmitting, to a UE, DCI indicating the selected LDPC base graph. This aspect enables efficient signaling of the selected base graph, reducing latency in base graph determination and ensuring proper coordination for encoding and decoding operations. Additionally, or alternatively, the wireless communication device 900 may be configured to or operable to support where the DCI includes a one-bit field indicating a base graph ID of the selected LDPC base graph. This aspect minimizes signaling overhead while providing explicit base graph indication, improving spectral efficiency and reducing control channel resource consumption. Additionally, or alternatively, the wireless communication device 900 may be configured to or operable to support transmitting DCI indicating the MCS index, and transmit RRC signaling indicating one or more parameters associated with the TBS. This aspect enables accurate communication of transmission parameters for proper encoding and decoding, improving reliability and reducing errors. Additionally, or alternatively, the wireless communication device 900 may be configured to or operable to support determining the TBS based on the RRC signaling, where the MCS index and the determined TBS implicitly indicate a base graph ID for selecting the LDPC base graph from the set of LDPC base graphs. This aspect eliminates the need for explicit base graph signaling, reducing control signaling overhead and improving spectral efficiency.

Additionally, or alternatively, the wireless communication device 900 may be configured to or operable to support determining the TBS and the MCS index, where the TBS is within a first TBS range and the MCS index is within a first MCS range, and where each LDPC base graph of the set of LDPC base graphs corresponds to a TBS range and an MCS range. This aspect enables systematic base graph selection based on defined parameter ranges, improving encoding reliability and ensuring optimal base graph matching for different transmission scenarios. Additionally, or alternatively, the wireless communication device 900 may be configured to or operable to support where the selected LDPC base graph corresponds to the first TBS range and the first MCS range and a second LDPC base graph corresponds to a second TBS range and a second MCS range, and where the second TBS range includes larger TBSs than the first TBS range and the second MCS range includes larger MCS indices than the first MCS range. This aspect enables differentiated base graph selection for varying throughput requirements, improving performance for both standard and high-throughput scenarios. Additionally, or alternatively, the wireless communication device 900 may be configured to or operable to support where at least one LDPC base graph of the set of LDPC base graphs is configured for high-throughput scenarios. This aspect enables the wireless communication device 900 to support ultra-high data rates beyond conventional limits, improving peak throughput performance for demanding applications. Additionally, or alternatively, the wireless communication device 900 may be configured to or operable to support where the selected LDPC base graph is associated with one or more TBs. This aspect enables consistent base graph application across multiple TBs, improving encoding efficiency and reducing processing complexity. Additionally, or alternatively, the wireless communication device 900 may be configured to or operable to support where the wireless communication device is a UE or an NE. This aspect enables flexible deployment across different device types in the wireless communications system.

The controller 906 may manage input and output signals for the wireless communication device 900. The controller 906 may also manage peripherals not integrated into the wireless communication device 900. In some implementations, the controller 906 may utilize an operating system such as iOS®, ANDROID®, WINDOWS®, or other operating systems. In some implementations, the controller 906 may be implemented as part of the processor 902.

In some implementations, the wireless communication device 900 may include at least one transceiver 908. In some other implementations, the wireless communication device 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas to receive a signal over the air or via a wireless medium. The receiver chain 910 may include at least one amplifier (e.g., a low-noise amplifier (LNA)) configured to amplify the received signal. The receiver chain 910 may include at least one demodulator configured to demodulate the received signal and obtain the transmitted data by reversing the modulation technique applied during transmission of the signal. The receiver chain 910 may include at least one decoder for decoding the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or the wireless medium.

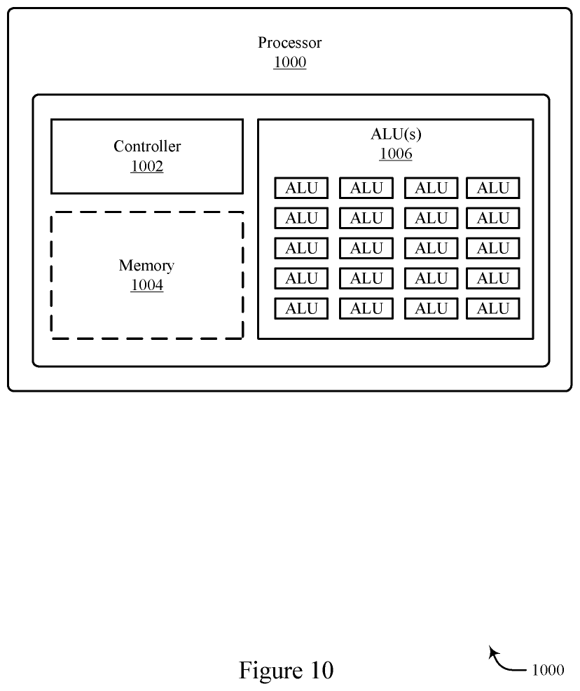

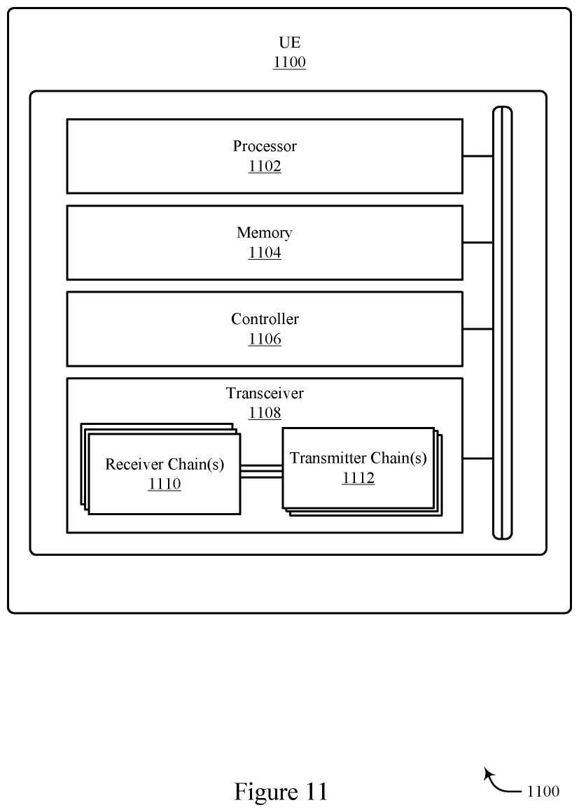

FIG. 10 illustrates an example of a processor 1000 in accordance with aspects of the present disclosure. The processor 1000 may be an example of a processor configured to perform various operations in accordance with examples as described herein. The processor 1000 may include a controller 1002 configured to perform various operations in accordance with examples as described herein. The processor 1000 may optionally include at least one memory 1004, which may be, for example, an L1/L2/L3 cache. Additionally, or alternatively, the processor 1000 may optionally include one or more arithmetic-logic units (ALUs) 1006. One or more of these components may be in electronic communication or otherwise coupled (e.g., operatively, communicatively, functionally, electronically, electrically) via one or more interfaces (e.g., buses).

The processor 1000 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1000) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1002 may be configured to manage and coordinate various operations (e.g., signaling, receiving, obtaining, retrieving, transmitting, outputting, forwarding, storing, determining, identifying, accessing, writing, reading) of the processor 1000 to cause the processor 1000 to support various operations in accordance with examples as described herein. For example, the controller 1002 may operate as a control unit of the processor 1000, generating control signals that manage the operation of various components of the processor 1000. These control signals include enabling or disabling functional units, selecting data paths, initiating memory access, and coordinating timing of operations.

The controller 1002 may be configured to fetch (e.g., obtain, retrieve, receive) instructions from the memory 1004 and determine subsequent instruction(s) to be executed to cause the processor 1000 to support various operations in accordance with examples as described herein. The controller 1002 may be configured to track memory addresses of instructions associated with the memory 1004. The controller 1002 may be configured to decode instructions to determine the operation to be performed and the operands involved. For example, the controller 1002 may be configured to interpret the instruction and determine control signals to be output to other components of the processor 1000 to cause the processor 1000 to support various operations in accordance with examples as described herein. Additionally, or alternatively, the controller 1002 may be configured to manage the flow of data within the processor 1000. The controller 1002 may be configured to control the transfer of data between registers, ALUs 1006, and other functional units of the processor 1000.

The memory 1004 may include one or more caches (e.g., memory local to or included in the processor 1000 or other memory, such as RAM, ROM, DRAM, SDRAM, SRAM, MRAM, flash memory, etc.). In some implementations, the memory 1004 may reside within or on a processor chipset (e.g., local to the processor 1000). In some other implementations, the memory 1004 may reside external to the processor chipset (e.g., remote to the processor 1000).

The memory 1004 may store computer-readable, computer-executable code including instructions that, when executed by the processor 1000, cause the processor 1000 to perform various functions described herein. The code may be stored in a non-transitory computer-readable medium such as system memory or another type of memory. The controller 1002 and/or the processor 1000 may be configured to execute computer-readable instructions stored in the memory 1004 to cause the processor 1000 to perform various functions. For example, the processor 1000 and/or the controller 1002 may be coupled with or to the memory 1004, the processor 1000, and the controller 1002, and may be configured to perform various functions described herein. In some examples, the processor 1000 may include multiple processors and the memory 1004 may include multiple memories. One or more of the multiple processors may be coupled with one or more of the multiple memories, which may, individually or collectively, be configured to perform various functions herein.

The one or more ALUs 1006 may be configured to support various operations in accordance with examples as described herein. In some implementations, the one or more ALUs 1006 may reside within or on a processor chipset (e.g., the processor 1000). In some other implementations, the one or more ALUs 1006 may reside external to the processor chipset (e.g., the processor 1000). One or more ALUs 1006 may perform one or more computations such as addition, subtraction, multiplication, and division on data. For example, one or more ALUs 1006 may receive input operands and an operation code, which determines an operation to be executed. One or more ALUs 1006 may be configured with a variety of logical and arithmetic circuits, including adders, subtractors, shifters, and logic gates, to process and manipulate the data according to the operation. Additionally, or alternatively, the one or more ALUs 1006 may support logical operations such as AND, OR, exclusive-OR (XOR), not-OR (NOR), and not-AND (NAND), enabling the one or more ALUs 1006 to handle conditional operations, comparisons, and bitwise operations.

The processor 1000 may support wireless communication in accordance with examples as disclosed herein. The processor 1000 may be configured to or operable to support at least one controller (e.g., the controller 1002) coupled with at least one memory (e.g., the memory 1004) and configured to cause the processor to select an LDPC base graph from a set of LDPC base graphs based on a TBS and an MCS index, and encode a TB based on the selected LDPC base graph. In this manner, the processor 1000 supports improved throughput and enhanced encoding performance by enabling selection of an appropriate LDPC base graph that matches the transmission requirements, thereby accommodating varying scenarios including ultra-high throughput applications.

Additionally, the processor 1000 may be configured to or operable to support any one or combination of transmitting, to a UE, DCI indicating the selected LDPC base graph. This aspect enables efficient signaling of the selected base graph, reducing latency in base graph determination and ensuring proper coordination for encoding and decoding operations. Additionally, or alternatively, the processor 1000 may be configured to or operable to support where the DCI includes a one-bit field indicating a base graph ID of the selected LDPC base graph. This aspect minimizes signaling overhead while providing explicit base graph indication, improving spectral efficiency and reducing control channel resource consumption. Additionally, or alternatively, the processor 1000 may be configured to or operable to support transmitting DCI indicating the MCS index, and transmitting RRC signaling indicating one or more parameters associated with the TBS. This aspect enables accurate communication of transmission parameters for proper encoding and decoding, improving reliability and reducing errors. Additionally, or alternatively, the processor 1000 may be configured to or operable to support determining the TBS based on the RRC signaling, where the MCS index and the determined TBS implicitly indicate a base graph ID for selecting the LDPC base graph from the set of LDPC base graphs. This aspect eliminates the need for explicit base graph signaling, reducing control signaling overhead and improving spectral efficiency.

Additionally, or alternatively, the processor 1000 may be configured to or operable to support determining the TBS and the MCS index, where the TBS is within a first TBS range and the MCS index is within a first MCS range, and where each LDPC base graph of the set of LDPC base graphs corresponds to a TBS range and an MCS range. This aspect enables systematic base graph selection based on defined parameter ranges, improving encoding reliability and ensuring optimal base graph matching for different transmission scenarios. Additionally, or alternatively, the processor 1000 may be configured to or operable to support where the selected LDPC base graph corresponds to the first TBS range and the first MCS range and a second LDPC base graph corresponds to a second TBS range and a second MCS range, and where the second TBS range includes larger TBSs than the first TBS range and the second MCS range includes larger MCS indices than the first MCS range. This aspect enables differentiated base graph selection for varying throughput requirements, improving performance for both standard and high-throughput scenarios. Additionally, or alternatively, the processor 1000 may be configured to or operable to support where at least one LDPC base graph of the set of LDPC base graphs is configured for high-throughput scenarios. This aspect enables the processor 1000 to support ultra-high data rates beyond conventional limits, improving peak throughput performance for demanding applications. Additionally, or alternatively, the processor 1000 may be configured to or operable to support where the selected LDPC base graph is associated with one or more TBs. This aspect enables consistent base graph application across multiple TBs, improving encoding efficiency and reducing processing complexity. Additionally, or alternatively, the processor 1000 may be configured to or operable to support where the wireless communication device is a UE or an NE. This aspect enables flexible deployment across different device types in the wireless communications system.

The processor 1000 may support wireless communication in accordance with examples as disclosed herein. The processor 1000 may be configured to or operable to support at least one controller (e.g., the controller 1002) coupled with at least one memory (e.g., the memory 1004) and configured to cause the processor to receive a TB that is encoded based on an LDPC base graph, the LDPC base graph selected from a set of LDPC base graphs based on a TBS and an MCS index, and decode the TB based on the LDPC base graph. In this manner, the processor 1000 supports improved throughput and enhanced decoding performance by enabling selection of an appropriate LDPC base graph that matches the transmission requirements, thereby accommodating varying scenarios including ultra-high throughput applications.

Additionally, the processor 1000 may be configured to or operable to support any one or combination of the following. For example, the processor 1000 may be configured to or operable to support any one or combination of receiving DCI indicating the LDPC base graph. This aspect enables efficient signaling of the selected base graph to the processor 1000, reducing latency in base graph determination and ensuring proper coordination between the network and the processor 1000 for decoding operations. Additionally, or alternatively, the processor 1000 may be configured to or operable to support where the DCI includes a one-bit field indicating a base graph ID of the LDPC base graph. This aspect minimizes signaling overhead while providing explicit base graph indication, improving spectral efficiency and reducing control channel resource consumption at the processor 1000. Additionally, or alternatively, the processor 1000 may be configured to or operable to support receiving DCI indicating the MCS index, and receiving RRC signaling indicating one or more parameters associated with the TBS. This aspect enables the processor 1000 to accurately determine transmission parameters for proper decoding, improving reliability and reducing decoding errors. Additionally, or alternatively, the processor 1000 may be configured to or operable to support determining the TBS based on the RRC signaling, and selecting the LDPC base graph based on the MCS index and the determined TBS. This aspect enables the processor 1000 to autonomously select the appropriate base graph, reducing signaling overhead and improving system efficiency. Additionally, or alternatively, the processor 1000 may be configured to or operable to support where the MCS index and the TBS implicitly indicate a base graph ID for selecting the LDPC base graph. This aspect eliminates the need for explicit base graph signaling, reducing control signaling overhead and improving spectral efficiency at the processor 1000.

Additionally, or alternatively, the processor 1000 may be configured to or operable to support where the TBS is within a first TBS range and the MCS index is within a first MCS range, and each LDPC base graph of the set of LDPC base graphs corresponds to a TBS range and an MCS range. This aspect enables systematic base graph selection based on defined parameter ranges, improving decoding reliability and ensuring optimal base graph matching for different transmission scenarios at the processor 1000. Additionally, or alternatively, the processor 1000 may be configured to or operable to support where the LDPC base graph corresponds to the first TBS range and the first MCS range and a second LDPC base graph corresponds to a second TBS range and a second MCS range, and the second TBS range includes larger TBSs than the first TBS range and the second MCS range includes larger MCS indices than the first MCS range. This aspect enables differentiated base graph selection for varying throughput requirements, improving performance for both standard and high-throughput scenarios at the processor 1000. Additionally, or alternatively, the processor 1000 may be configured to or operable to support where at least one LDPC base graph of the set of LDPC base graphs is configured for high-throughput scenarios. This aspect enables the processor 1000 to support ultra-high data rates beyond conventional limits, improving peak throughput performance for demanding applications. Additionally, or alternatively, the processor 1000 may be configured to or operable to support where the LDPC base graph is associated with one or more TBs. This aspect enables consistent base graph application across multiple TBs, improving decoding efficiency and reducing processing complexity at the processor 1000.

FIG. 11 illustrates an example of a UE 1100 in accordance with aspects of the present disclosure. The UE 1100 may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces.

The processor 1102, the memory 1104, the controller 1106, or the transceiver 1108, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 1102 may include an intelligent hardware device (e.g., a general-purpose processor, a DSP, a CPU, an ASIC, an FPGA, or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the UE 1100 to perform various functions of the present disclosure.

The memory 1104 may include volatile or non-volatile memory. The memory 1104 may store computer-readable, computer-executable code including instructions when executed by the processor 1102 cause the UE 1100 to perform various functions described herein. The code may be stored in a non-transitory computer-readable medium such as the memory 1104 or another type of memory. Computer-readable media include both non-transitory computer storage media and communication media including any medium that facilitates transfer of a computer program from one place to another. A non-transitory storage medium may be any available medium that may be accessed by a general-purpose or special-purpose computer.

In some implementations, the processor 1102 and the memory 1104 coupled with the processor 1102 may be configured to cause the UE 1100 to perform one or more of the functions described herein (e.g., executing, by the processor 1102, instructions stored in the memory 1104). For example, the processor 1102 may support wireless communication at the UE 1100 in accordance with examples as disclosed herein. The UE 1100 may be configured to or operable to support a means for receiving a TB that is encoded based on an LDPC base graph, the LDPC base graph selected from a set of LDPC base graphs based on a TBD and an MCS index, and decoding the TB based on the LDPC base graph. In this manner, the UE 1100 supports improved throughput and enhanced decoding performance by enabling selection of an appropriate LDPC base graph that matches the transmission requirements, thereby accommodating varying scenarios including ultra-high throughput applications.

Additionally, the UE 1100 may be configured to or operable to support any one or combination of the following. For example, the UE 1100 may be configured to or operable to support any one or combination of receiving DCI indicating the LDPC base graph. This aspect enables efficient signaling of the selected base graph to the UE 1100, reducing latency in base graph determination and ensuring proper coordination between the network and the UE 1100 for decoding operations. Additionally, or alternatively, the UE 1100 may be configured to or operable to support where the DCI includes a one-bit field indicating a base graph ID of the LDPC base graph. This aspect minimizes signaling overhead while providing explicit base graph indication, improving spectral efficiency and reducing control channel resource consumption at the UE 1100. Additionally, or alternatively, the UE 1100 may be configured to or operable to support receiving DCI indicating the MCS index, and receiving RRC signaling indicating one or more parameters associated with the TBS. This aspect enables the UE 1100 to accurately determine transmission parameters for proper decoding, improving reliability and reducing decoding errors. Additionally, or alternatively, the UE 1100 may be configured to or operable to support determining the TBS based on the RRC signaling, and selecting the LDPC base graph based on the MCS index and the determined TBS. This aspect enables the UE 1100 to autonomously select the appropriate base graph, reducing signaling overhead and improving system efficiency. Additionally, or alternatively, the UE 1100 may be configured to or operable to support where the MCS index and the TBS implicitly indicate a base graph ID for selecting the LDPC base graph. This aspect eliminates the need for explicit base graph signaling, reducing control signaling overhead and improving spectral efficiency at the UE 1100.

Additionally, or alternatively, the UE 1100 may be configured to or operable to support where the TBS is within a first TBS range and the MCS index is within a first MCS range, and each LDPC base graph of the set of LDPC base graphs corresponds to a TBS range and an MCS range. This aspect enables systematic base graph selection based on defined parameter ranges, improving decoding reliability and ensuring optimal base graph matching for different transmission scenarios at the UE 1100. Additionally, or alternatively, the UE 1100 may be configured to or operable to support where the LDPC base graph corresponds to the first TBS range and the first MCS range and a second LDPC base graph corresponds to a second TBS range and a second MCS range, and the second TBS range includes larger TBSs than the first TBS range and the second MCS range includes larger MCS indices than the first MCS range. This aspect enables differentiated base graph selection for varying throughput requirements, improving performance for both standard and high-throughput scenarios at the UE 1100. Additionally, or alternatively, the UE 1100 may be configured to or operable to support where at least one LDPC base graph of the set of LDPC base graphs is configured for high-throughput scenarios. This aspect enables the UE 1100 to support ultra-high data rates beyond conventional limits, improving peak throughput performance for demanding applications. Additionally, or alternatively, the UE 1100 may be configured to or operable to support where the LDPC base graph is associated with one or more TBs. This aspect enables consistent base graph application across multiple TBs, improving decoding efficiency and reducing processing complexity at the UE 1100.

Additionally, or alternatively, the UE 1100 may support at least one memory (e.g., the memory 904) and at least one processor (e.g., the processor 902) coupled with the at least one memory and configured to cause the UE to receive a TB that is encoded based on an LDPC base graph, the LDPC base graph selected from a set of LDPC base graphs based on a TBS and an MCS index, and decode the TB based on the LDPC base graph. In this manner, the UE 1100 supports improved throughput and enhanced decoding performance by enabling selection of an appropriate LDPC base graph that matches the transmission requirements, thereby accommodating varying scenarios including ultra-high throughput applications.

Additionally, the UE 1100 may be configured to or operable to support any one or combination of the following. For example, the UE 1100 may be configured to or operable to support any one or combination of receiving DCI indicating the LDPC base graph. This aspect enables efficient signaling of the selected base graph to the UE 1100, reducing latency in base graph determination and ensuring proper coordination between the network and the UE 1100 for decoding operations. Additionally, or alternatively, the UE 1100 may be configured to or operable to support where the DCI includes a one-bit field indicating a base graph ID of the LDPC base graph. This aspect minimizes signaling overhead while providing explicit base graph indication, improving spectral efficiency and reducing control channel resource consumption at the UE 1100. Additionally, or alternatively, the UE 1100 may be configured to or operable to support receiving DCI indicating the MCS index, and receiving RRC signaling indicating one or more parameters associated with the TBS. This aspect enables the UE 1100 to accurately determine transmission parameters for proper decoding, improving reliability and reducing decoding errors. Additionally, or alternatively, the UE 1100 may be configured to or operable to support determining the TBS based on the RRC signaling, and selecting the LDPC base graph based on the MCS index and the determined TBS. This aspect enables the UE 1100 to autonomously select the appropriate base graph, reducing signaling overhead and improving system efficiency. Additionally, or alternatively, the UE 1100 may be configured to or operable to support where the MCS index and the TBS implicitly indicate a base graph ID for selecting the LDPC base graph. This aspect eliminates the need for explicit base graph signaling, reducing control signaling overhead and improving spectral efficiency at the UE 1100.

Additionally, or alternatively, the UE 1100 may be configured to or operable to support where the TBS is within a first TBS range and the MCS index is within a first MCS range, and each LDPC base graph of the set of LDPC base graphs corresponds to a TBS range and an MCS range. This aspect enables systematic base graph selection based on defined parameter ranges, improving decoding reliability and ensuring optimal base graph matching for different transmission scenarios at the UE 1100. Additionally, or alternatively, the UE 1100 may be configured to or operable to support where the LDPC base graph corresponds to the first TBS range and the first MCS range and a second LDPC base graph corresponds to a second TBS range and a second MCS range, and the second TBS range includes larger TBSs than the first TBS range and the second MCS range includes larger MCS indices than the first MCS range. This aspect enables differentiated base graph selection for varying throughput requirements, improving performance for both standard and high-throughput scenarios at the UE 1100. Additionally, or alternatively, the UE 1100 may be configured to or operable to support where at least one LDPC base graph of the set of LDPC base graphs is configured for high-throughput scenarios. This aspect enables the UE 1100 to support ultra-high data rates beyond conventional limits, improving peak throughput performance for demanding applications. Additionally, or alternatively, the UE 1100 may be configured to or operable to support where the LDPC base graph is associated with one or more TBs. This aspect enables consistent base graph application across multiple TBs, improving decoding efficiency and reducing processing complexity at the UE 1100.

The controller 1106 may manage input and output signals for the UE 1100. The controller 1106 may also manage peripherals not integrated into the UE 1100. In some implementations, the controller 1106 may utilize an operating system such as iOS®, ANDROID®, WINDOWS®, or other operating systems. In some implementations, the controller 1106 may be implemented as part of the processor 1102.

In some implementations, the UE 1100 may include at least one transceiver 1108. In some other implementations, the UE 1100 may have more than one transceiver 1108. The transceiver 1108 may represent a wireless transceiver. The transceiver 1108 may include one or more receiver chains 1110, one or more transmitter chains 1112, or a combination thereof.

A receiver chain 1110 may be configured to receive signals (e.g., control information, data, packets) over a wireless medium. For example, the receiver chain 1110 may include one or more antennas to receive a signal over the air or wireless medium. The receiver chain 1110 may include at least one amplifier (e.g., a low-noise amplifier (LNA)) configured to amplify the received signal. The receiver chain 1110 may include at least one demodulator configured to demodulate the received signal and obtain the transmitted data by reversing the modulation technique applied during transmission of the signal. The receiver chain 1110 may include at least one decoder for decoding the demodulated signal to receive the transmitted data.

A transmitter chain 1112 may be configured to generate and transmit signals (e.g., control information, data, packets). The transmitter chain 1112 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or wireless medium.

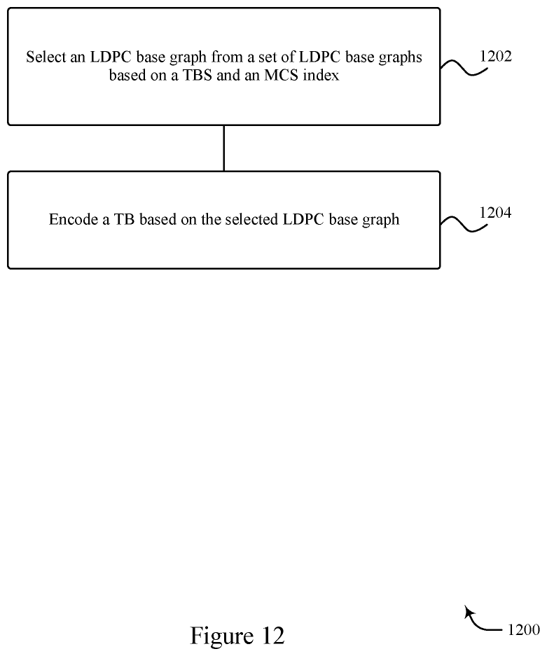

FIG. 12 illustrates a flowchart of a method 1200 in accordance with aspects of the present disclosure. The operations of the method may be implemented by a wireless communication device (e.g., an NE, a UE, a decoder) as described herein. In some implementations, the wireless communication device may execute a set of instructions to control the function elements of the wireless communication device to perform the described functions. It should be noted that the method described herein describes a possible implementation, and that the operations and the steps may be rearranged or otherwise modified and that other implementations are possible.

At 1202, the method may include selecting an LDPC base graph from a set of LDPC base graphs based on a TBS and an MCS index. The operations of 1202 may be performed in accordance with examples as described herein. In some implementations, aspects of the operations of 1202 may be performed by a wireless communication device as described with reference to FIG. 9.

At 1204, the method may include encoding a TB based on the selected LDPC base graph. The operations of 1204 may be performed in accordance with examples as described herein. In some implementations, aspects of the operations of 1204 may be performed by a wireless communication device as described with reference to FIG. 9.

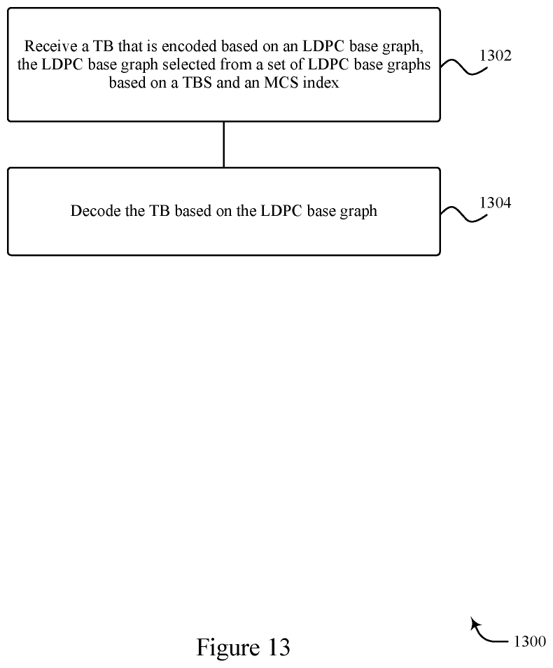

FIG. 13 illustrates a flowchart of a method 1300 in accordance with aspects of the present disclosure. The operations of the method may be implemented by a UE as described herein. In some implementations, the UE may execute a set of instructions to control the functional elements of the UE to perform the described functions. It should be noted that the method described herein describes a possible implementation, and that the operations and the steps may be rearranged or otherwise modified and that other implementations are possible.

At 1302, the method may include receiving a TB that is encoded based on an LDPC base graph, the LDPC base graph selected from a set of LDPC base graphs based on a TBS and an MCS index. The operations of 1302 may be performed in accordance with examples as described herein. In some implementations, aspects of the operations of 1302 may be performed by a UE as described with reference to FIG. 11.

At 1304, the method may include decoding the TB based on the LDPC base graph. The operations of 1304 may be performed in accordance with examples as described herein. In some implementations, aspects of the operations of 1304 may be performed by a UE as described with reference to FIG. 11.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A wireless communication device for wireless communication, comprising:
at least one memory; and
at least one processor coupled with the at least one memory and operable to cause the wireless communication device to:
select a low-density parity-check (LDPC) base graph from a set of LDPC base graphs based at least in part on a transport block size (TBS) and a modulation and coding scheme (MCS) index; and
encode a transport block (TB) based at least in part on the selected LDPC base graph.

2. The wireless communication device of claim 1, wherein the at least one processor is further operable to cause the wireless communication device to transmit, to a user equipment (UE), downlink control information (DCI) indicating the selected LDPC base graph.

3. The wireless communication device of claim 2, wherein the DCI includes a one-bit field indicating a base graph identifier (ID) of the selected LDPC base graph.

4. The wireless communication device of claim 1, wherein the at least one processor is further operable to cause the wireless communication device to:
transmit downlink control information (DCI) indicating the MCS index; and
transmit radio resource control (RRC) signaling indicating one or more parameters associated with the TBS.

5. The wireless communication device of claim 4, wherein the at least one processor is further operable to cause the wireless communication device to: determine the TBS based at least in part on the RRC signaling, wherein the MCS index and the determined TBS implicitly indicate a base graph identifier (ID) for selecting the LDPC base graph from the set of LDPC base graphs.

6. The wireless communication device of claim 1, wherein the at least one processor is further operable to cause the wireless communication device to determine the TBS and the MCS index, wherein the TBS is within a first TBS range and the MCS index is within a first MCS range, and wherein each LDPC base graph of the set of LDPC base graphs corresponds to a TBS range and an MCS range.

7. The wireless communication device of claim 6, wherein the selected LDPC base graph corresponds to the first TBS range and the first MCS range and a second LDPC base graph corresponds to a second TBS range and a second MCS range, and wherein the second TBS range includes larger TBSs than the first TBS range and the second MCS range includes larger MCS indices than the first MCS range.

8. The wireless communication device of claim 1, wherein at least one LDPC base graph of the set of LDPC base graphs is configured for high-throughput scenarios.

9. The wireless communication device of claim 1, wherein the selected LDPC base graph is associated with one or more TBs.

10. The wireless communication device of claim 1, wherein the wireless communication device is a user equipment (UE) or a network equipment (NE).

11. A user equipment (UE) for wireless communication, comprising:
at least one memory; and
at least one processor coupled with the at least one memory and operable to cause the UE to:
receive a transport block (TB) that is encoded based at least in part on a low-density parity-check (LDPC) base graph, the LDPC base graph selected from a set of LDPC base graphs based at least in part on a transport block size (TBS) and a modulation and coding scheme (MCS) index; and
decode the TB based at least in part on the LDPC base graph.

12. The UE of claim 11, wherein the at least one processor is further operable to cause the UE to receive downlink control information (DCI) indicating the LDPC base graph.

13. The UE of claim 12, wherein the DCI includes a one-bit field indicating a base graph identifier (ID) of the LDPC base graph.

14. The UE of claim 11, wherein the at least one processor is further operable to cause the UE to:
receive downlink control information (DCI) indicating the MCS index; and
receive radio resource control (RRC) signaling indicating one or more parameters associated with the TBS.

15. The UE of claim 14, wherein the at least one processor is further operable to cause the UE to:
determine the TBS based at least in part on the RRC signaling; and
select the LDPC base graph based at least in part on the MCS index and the determined TBS.

16. The UE of claim 15, wherein the MCS index and the TBS implicitly indicate a base graph identifier (ID) for selecting the LDPC base graph.

17. The UE of claim 11, wherein the TBS is within a first TBS range and the MCS index is within a first MCS range, and wherein each LDPC base graph of the set of LDPC base graphs corresponds to a TBS range and an MCS range.

18. The UE of claim 17, wherein the LDPC base graph corresponds to the first TBS range and the first MCS range and a second LDPC base graph corresponds to a second TBS range and a second MCS range, and wherein the second TBS range includes larger TBSs than the first TBS range and the second MCS range includes larger MCS indices than the first MCS range.

19. A method performed by a wireless communication device, the method comprising:
selecting a low-density parity-check (LDPC) base graph from a set of LDPC base graphs based at least in part on a transport block size (TBS) and a modulation and coding scheme (MCS) index; and
encoding a transport block (TB) based at least in part on the selected LDPC base graph.

20. A method performed by a user equipment (UE), the method comprising:
receiving a transport block (TB) that is encoded based at least in part on a low-density parity-check (LDPC) base graph, the LDPC base graph selected from a set of LDPC base graphs based at least in part on a transport block size (TBS) and a modulation and coding scheme (MCS) index; and
decoding the TB based at least in part on the LDPC base graph.
